(19) United States
(12) Patent Application Publication
(10) Pub. No.: US 2011/0006988 A1
(43) Pub. Date: Jan. 13, 2011

(54) MULTI-MODE MOUSE DEVICE

(75) Inventors: Yuan-Lan Yang, Taipei (TW); Chun-Nan Su, Taipei (TW)

Correspondence Address: KIRTON AND MCCONKIE, 60 EAST SOUTH TEMPLE,, SUITE 1800, SALT LAKE CITY, UT, 84111, US

(73) Assignee: PRIMAX ELECTRONICS LTD., Taipei (TW)

(21) Appl. No.: 12/609,767

(22) Filed: Oct. 30, 2009

(30) Foreign Application Priority Data
Jul. 10, 2009 (TW) 098123324

(51) Int. Cl. G09G 5/08

(52) U.S. Cl. 345/163

(57) ABSTRACT

A multi-mode mouse device includes a mode-switching element on a surface of a mouse body. By manipulating the mode-switching element, the mouse device could be operated in a working mode or a power-saving mode according to the user's requirements. In the working mode, the response cycle of the motion sensor within the mouse device is maintained constant. In the power-saving mode, the response cycle is adjusted according to the downshift time period of the mouse device. By manipulating the mode-switching element, the mouse device could meet the demands of achieving optimal sensitive degree and power-saving efficacy.

### FIELD OF THE INVENTION

The present invention relates to an input device, and more particularly to a multi-mode mouse device operable in multiple sensing modes with different sensitive degrees.

### BACKGROUND OF THE INVENTION

Due to the amazing power of computers, computers become essential data processing apparatuses in our daily lives. For example, the users could acquire important information (e.g. meteorological information, traffic information, news or uniform invoice number) via the computers. In addition, the users could communicate with their friends through instant messaging software, e-mails or video transmission by using the computers. As known, a human-machine interface input device is an essential component of the computer for communicating the user and the computer. In particular, a mouse device is a widely-used human-machine interface input device.

In comparison with keyboards, mouse devices have compact volume and are suitably handheld. For helping the user well operate the computer, many novel mouse devices with expanded functions are developed in views of humanization and user-friendliness. For example, in a case that the common expanded functions are performed, the mouse devices could be served as network phones, slide presenters, multimedia player's remote controllers, laser pointers, and the like. In addition to the expanded functions, the mouse devices are served as cursor control devices when the main functions of the mouse devices are performed. For achieving a power-saving efficacy, most mouse devices have multi-stage sensing modes. FIG. 1 is a schematic timing waveform diagram illustrating multi-stage sensing modes of a mouse device according to the prior art. According to a downshift time period when the mouse device is idle, a response cycle of the motion sensor of the mouse device is dynamically adjusted. The response cycle comprises a sensing time interval and a non-sensing time interval. For each response cycle in any sensing mode, the sensing time interval is constant. For example, in a first-stage sensing mode of the mouse device, the downshift time period 1 is 1 second and the response cycle 1 of the motion sensor is 0.5 ms. The sensing time interval 1 is 25 ms and the non-sensing time interval 1 is 25 ms. In a case that the mouse device has been idle for a time period shorter than 1 second, a coordinate data is issued by the motion sensor in every 25 ms. Whereas, in a case that the mouse device has been idle for a time period longer than 1 second, the operating mode of the mouse device is switched from the first-stage sensing mode to a second-stage sensing mode. In a second-stage sensing mode of the mouse device, the downshift time period 2 is 10 second and the response cycle 2 of the motion sensor is 100 ms. The sensing time interval 2 is also 25 ms but the non-sensing time interval 2 is 75 ms. Under this circumstance, a coordinate data is issued by the motion sensor in every 75 ms.

From the above discussion, as the time period of idling the mouse device is increased, the coordinate data is provided during a longer response cycle by stages. In other words, as the time period of idling the mouse device is increased, the counts of coordinate data provided in a unit time period are reduced in order to achieve a power-saving efficacy. The downshift time period, the response cycle, the sensing time interval and the non-sensing time interval are presented herein for purpose of illustration and description only, and are not limited to the specified lengths of time periods.

However, for some tasks performed on the computer and controlled by the mouse device, the mouse device is not suitably operated in multi-stage sensing modes. For example, in a case that gaming software is executed on the computer and controlled by the mouse device, the mouse device may be temporarily idle to wait for occurrence of a specified event, and the mouse device needs to be instantly operated to respond to the specified event after occurrence of the specified event. If the mouse is idle and the mouse is in a sensing mode having a long downshift time period to provide the coordinate data, the mouse fails to instantly respond to the specified event, because the non-sensing time interval is prolonged. In other words, the mouse device is not suitably operated in the multi-stage sensing modes in this situation. For increasing convenience and utilization flexibility, there is a need of providing a mouse device operable in multi-stage sensing modes, in which the multi-stage sensing modes could be enabled or disabled according to the users' requirements.

### SUMMARY OF THE INVENTION

It is an object of the present invention to provide a multi-mode mouse device having a mode-switching element, in which the mouse device could be operable in multiple sensing modes with different sensitive degrees according to the user's requirements.

In accordance with an aspect of the present invention, there is provided a multi-mode mouse device operable in multiple sensing modes with different sensitive degrees. The multi-mode mouse device includes a mouse body, a mode-switching element, a microprocessor and a motion sensor. The mode-switching element is disposed on a surface of the mouse body for providing a mode signal. The microprocessor disposed within the mouse body and electrically connected with the mode-switching element, wherein the microprocessor issues a reset signal in response to the mode signal. The motion sensor is disposed within the mouse body and electrically connected with the microprocessor for providing a coordinate data to the microprocessor. The motion sensor is operated in a working mode or a power-saving mode. The motion sensor is restored to the working mode in response to the reset signal.

In an embodiment, a downshift time period and a response cycle of the motion sensor in the working mode are respectively shorter than those of the motion sensor in the power-saving mode.

In an embodiment, a non-sensing time interval of the response cycle in the working mode is shorter than that in the power-saving mode.

In an embodiment, if the mouse body has been kept stationary for a predetermined time period, the motion sensor is switched from the working mode to the power-saving mode.

In an embodiment, the mode signal is a working mode signal or a power-saving mode signal.

In an embodiment, the microprocessor issues the reset signal when the mode signal is the working mode signal, so that the motion sensor is maintained in the working mode.

In an embodiment, the microprocessor issues the reset signal when the mode signal is the power-saving mode signal. If the motion sensor has been idle for a predetermined time period, the motion sensor is switched from the working mode to the power-saving mode.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic timing waveform diagram illustrating multi-stage sensing modes of a mouse device according to the prior art;

FIG. 2A is a schematic perspective view illustrating the outward appearance of a multi-mode mouse device according to an embodiment of the present invention;

FIG. 2B is a schematic bottom view of a multi-mode mouse device according to an embodiment of the present invention; and

FIG. 3 is a schematic circuit block diagram illustrating operations of a multi-mode mouse device according to an embodiment of the present invention.

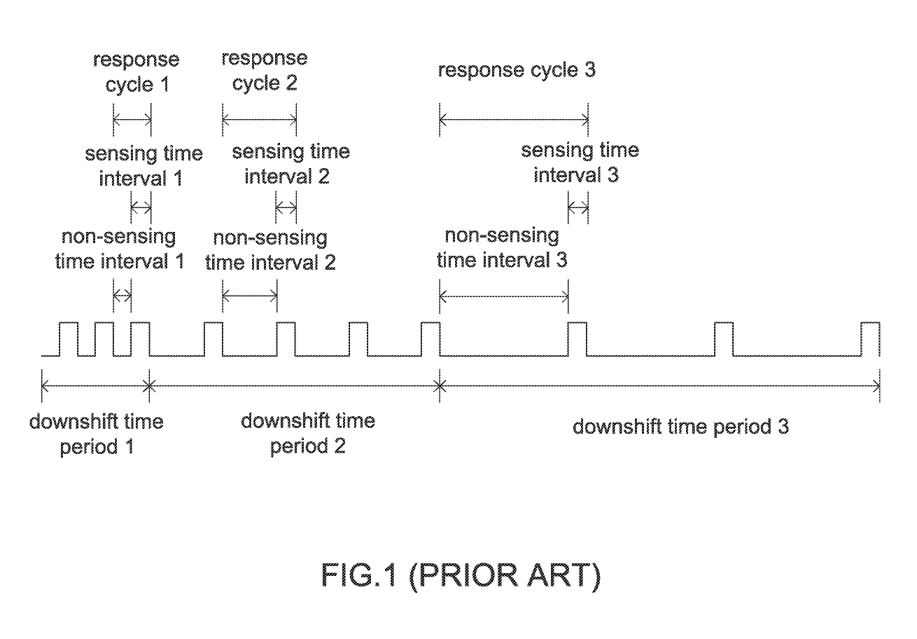

### DETAILED DESCRIPTION OF THE PREFERRED EMBODIMENT

The present invention provides a multi-mode mouse device. The multi-mode mouse device has a mode-switching element. By manipulating the mode-switching element, the mouse device could be operated in a working mode or a power-saving mode in order to adjust the sensitive degrees as required.

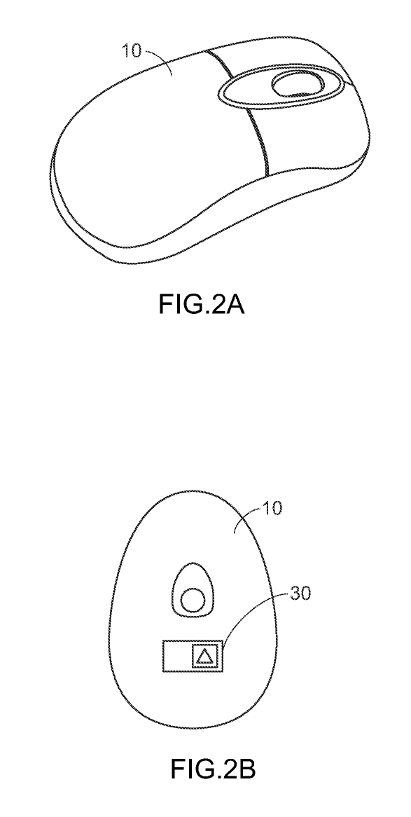

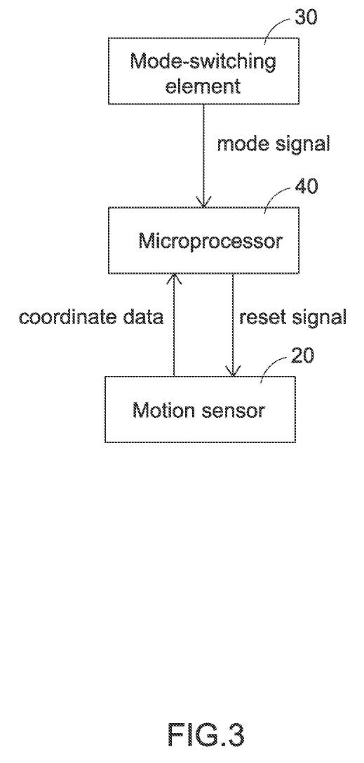

FIG. 2A is a schematic perspective view illustrating the outward appearance of a multi-mode mouse device according to an embodiment of the present invention. FIG. 2B is a schematic bottom view of a multi-mode mouse device according to an embodiment of the present invention. FIG. 3 is a schematic circuit block diagram illustrating operations of a multi-mode mouse device according to an embodiment of the present invention. Please refer to FIGS. 2A, 2B and 3. The multi-mode mouse device comprises a mouse body 10, a motion sensor 20, a mode-switching element 30, and a microprocessor 40. The motion sensor 20 and the microprocessor 40 are disposed within the mouse body 10 and electrically connected with each other. The mode-switching element 30 is disposed on a surface of the mouse body 10, and electrically connected with the micro-processor 40. In this embodiment, the mode-switching element 30 is disposed on a bottom surface of the mouse body 10.

The motion sensor 20 has multi-stage sensing modes. In an embodiment, the multi-stage sensing modes comprise a working mode and a power-saving mode. In the working mode of the mouse device, the downshift time period and the response cycle are relatively shorter. In the power-saving mode of the mouse device, the downshift time period and the response cycle are relatively longer. The response cycle comprises a sensing time interval and a non-sensing time interval. For each response cycle in the working mode or the power-saving mode, the sensing time interval is constant. In addition, the non-sensing time interval of the response cycle in the working mode is shorter than the non-sensing time interval of the response cycle in the power-saving mode. In a case that the mouse body 10 has been kept stationary for a predetermined time period (i.e. the downshift time period in the working mode), the motion sensor 20 is switched from the working mode to a power-saving mode. The mode-switching element 30 could issue a mode signal. The mode signal is a working mode signal or a power-saving mode signal. According to the practical requirements, the user could manipulate the mode-switching element 30 to issue the working mode signal or the power-saving mode signal. In response to the power-saving mode signal, the microprocessor 40 is enabled to issue a reset signal such that the motion sensor 20 is operated in the multi-stage sensing mode. In response to the working mode signal, the microprocessor 40 is enabled to issue a reset signal such that the motion sensor 20 is maintained in the working mode.

When the microprocessor 40 issues a reset signal to the motion sensor 20 in response to the power-saving mode signal, the motion sensor 20 will be restored to the working mode, and then the motion sensor 20 will provide coordinate data to the microprocessor 40 in a relatively shorter response cycle within a relatively shorter downshift time period. If the mouse body 10 has been kept stationary for the predetermined time period in the working mode, the motion sensor 20 will be switched from the working mode to the power-saving mode, and then the motion sensor 20 will provide coordinate data to the microprocessor 40 in a relatively longer response cycle within a relatively longer downshift time period. Since the non-sensing time interval of the response cycle in the power-saving mode is longer than the non-sensing time interval of the response cycle in the working mode, the motion sensor 20 in the power-saving mode provides less coordinate data in a unit time period when compared with the motion sensor 20 in the working mode. As a consequence, the power-saving efficacy is achieved.

When the microprocessor 40 issues a reset signal to the motion sensor 20 in response to the working mode signal, the motion sensor 20 is maintained in the working mode, and then the motion sensor 20 continuously provides coordinate data to the microprocessor 40 in a relatively shorter response cycle. As a consequence, a high response sensitive degree is obtained. In an embodiment, a reset signal is periodically issued to the motion sensor 20 by the microprocessor 40 such that the motion sensor 20 is continuously maintained in the working mode. Alternatively, when the working mode signal is received by the microprocessor 40, the motion sensor 20 is continuously maintained in the working mode by specified software or hardware components.

Hereinafter, the operations of multi-mode mouse device of the present invention will be illustrated in more details with reference to FIGS. 2 and 3. For example, during a task of chatting via text messages, browsing web pages or editing documents are performed, the mouse device is frequently idle and the mouse device does not need to be instantly operated to respond to a new event. For reducing power consumption, the user could manipulate the mode-switching element 30 on the bottom surface of the mouse body 10 such that the mode signal is a power-saving mode signal and issued to the microprocessor 40. When the power-saving mode signal is received by the microprocessor 40, the microprocessor 40 issues a reset signal to the motion sensor 20 and thus the motion sensor 20 is restored to the working mode. If the mouse device is continuously operated and the motion of the mouse device is detected by the motion sensor 20, the motion sensor 20 will be maintained in the working mode and provide coordinate data to the microprocessor 40 in a relatively shorter response cycle (e.g. 50 ms). If the mouse body 10 has been kept stationary for a predetermined time period (i.e. the downshift time period in the working mode, e.g. 1 second), the motion sensor 20 will be switched from the working mode to a power-saving mode and provide coordinate data to the microprocessor 40 in a relatively longer response cycle (e.g. 100 ms). Under this circumstance, the motion sensor 20 in the power-saving mode provides less coordinate data in a unit time period, and thus the power-saving efficacy is achieved.

On the other hand, during a task of playing games between the user and the user's friend, the mouse device needs to be instantly operated to respond to a new event. The user could manipulate the mode-switching element 30 on the bottom surface of the mouse body 10 such that the mode signal is a working mode signal and issued to the microprocessor 40. When the working mode signal is received by the microprocessor 40, the microprocessor 40 issues a reset signal to the motion sensor 20 and thus the motion sensor 20 is continuously maintained in the working mode. In other words, even if the mouse device is idle, the motion sensor 20 will not be switched from the working mode to the power-saving mode. Under this circumstance, instant response and optimal sensitive degree are obtained whenever the mouse device is used by the user.

In another embodiment, during the microprocessor 40 issues a reset signal to the motion sensor 20 in response to the working mode signal, the information associated with a downshift time period and a corresponding response cycle is simultaneously transmitted to the motion sensor 20 in order to change settings of the motion sensor 20. Alternatively, during the microprocessor 40 issues a reset signal to the motion sensor 20 in response to the power-saving mode signal, the information associated with multiple downshift time periods and corresponding response cycles is simultaneously transmitted to the motion sensor 20 in order to change settings of the motion sensor 20. In a further embodiment of the present invention, the power-saving mode of the motion sensor 20 includes a plurality of power-saving statuses. These power-saving statuses have respective downshift time periods and respective response cycles. If the mouse device is idle for a longer time period, the motion sensor 20 provides coordinate data to the microprocessor 40 in a longer downshift time period and a longer response cycle.

From the above description, the multi-mode mouse device of the present invention has a mode-switching element. By manipulating the mode-switching element, the mouse device could be operated in a working mode or a power-saving mode in order to adjust the sensitive degrees according to the user's requirements. As a consequence, the mouse device of the present invention could meet the demands of achieving high response speed and power-saving efficacy.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A multi-mode mouse device operable in multiple sensing modes with different sensitive degrees, said multi-mode mouse device comprising:
a mouse body;
a mode-switching element disposed on a surface of said mouse body for providing a mode signal;
a microprocessor disposed within said mouse body and electrically connected with said mode-switching element, wherein said microprocessor issues a reset signal in response to said mode signal; and
a motion sensor disposed within said mouse body and electrically connected with said microprocessor for providing a coordinate data to said microprocessor, wherein said motion sensor is operated in a working mode or a power-saving mode, and said motion sensor is restored to said working mode in response to said reset signal.

2. The multi-mode mouse device according to claim 1 wherein a downshift time period and a response cycle of said motion sensor in said working mode are respectively shorter than those of said motion sensor in said power-saving mode.

3. The multi-mode mouse device according to claim 2 wherein a non-sensing time interval of said response cycle in said working mode is shorter than that in said power-saving mode.

4. The multi-mode mouse device according to claim 1 wherein if said mouse body has been kept stationary for a predetermined time period, said motion sensor is switched from said working mode to said power-saving mode.

5. The multi-mode mouse device according to claim 1 wherein said mode signal is a working mode signal or a power-saving mode signal.

6. The multi-mode mouse device according to claim 5 wherein said microprocessor issues said reset signal when said mode signal is said working mode signal, so that said motion sensor is maintained in said working mode.

7. The multi-mode mouse device according to claim 5 wherein said microprocessor issues said reset signal when said mode signal is said power-saving mode signal, and if said motion sensor has been idle for a predetermined time period, said motion sensor is switched from said working mode to said power-saving mode.
